(19) United States
(12) Patent Application Publication
(10) Pub. No.: US 2010/0141021 A1
(43) Pub. Date: Jun. 10, 2010

(54) Composite wheel with 3-dimensional core

(76) Inventors: Tomer Hendel, Santa Monica, CA (US); Guy Hendel, Santa Monica, CA (US)

Correspondence Address: THE MUELLER LAW OFFICE, P.C., 12951 Harwick Lane, San Diego, CA, 92130, US

(21) Appl. No.: 12/315,595

(22) Filed: Dec. 4, 2008

(51) Int. Cl. B60B 5/02; B21D 53/26

(52) U.S. Cl. 301/64.703; 29/894.34

(57) ABSTRACT

A composite wheel formed in a single piece with a three-dimensional honeycomb core and which may also include a bead seat to assist in keeping a tire in place. The device may be formed by employing a modified resin infusion process or modified resin transfer process.

### BACKGROUND OF THE INVENTION

1. Field of the Invention

The present invention relates to the design and manufacture of a composite wheel, and specifically a composite wheel with a three-dimensional honeycomb core.

The benefits of composite wheels are that they are lighter in weight, and less expensive to manufacture than metal wheels. Unfortunately, these benefits are currently achieved at the expense of strength, because to obtain the strength comparable to that of metal wheels, the thickness of the composite wheel must be increased so that the expected weight advantage is diminished, or lost.

One solution to the stiffness issue is to use a three-dimensional core material to increase the stiffness of the wheel, while keeping the weight to a minimum.

2. Description of the Related Art

Composite wheels are typically made from two pieces. For example, the wheel may be split vertically so that a first piece is formed, then a second piece is secured to the first with metal bolts. Other approaches have taught that the pieces may be secured by sleeve and receptor collar arrangement, or by glue.

These and similar approaches are described in varying detail in the following references:

U.S. Pat. No. 5,277,479 to Koyama, et al.

U.S. Pat. No. 4,749,235 to McDougall

U.S. Pat. No. 4,636,344 to McDougall

U.S. Patent Application Publication 2008/0053586 to Hanada, et al.

U.S. Patent Application Publication 2006/0113016 to Cron, et al.

U.S. Patent Application Publication 2003/0189373 to Spoelstra

U.S. Patent Application Publication 2003/0080609 to Darnell

Foreign: International Publication No. WO 93/01930 to Harding
Patent Abstracts of Japan No. JP 61-135801 to Yuzuru
Patent Abstracts of Japan No. JP 56-122 to Yoshiyuki
Patent Abstracts of Japan No. JP 2-125713 to Eiji
Patent Abstracts of Japan No. JP 2003-230904 to Masayoshi

### SUMMARY OF THE INVENTION

The present invention employs a composite rim and a composite disc, with a three-dimensional honeycomb core permanently embedded in the disc for additional stiffness.

In a preferred embodiment, the core may be a 3D core constructed from aluminum. Alternative embodiments employ cores made of wood or foam, Nomex, titanium or any other material possessing sufficient stiffness and strength.

The composite wheel can be formed by an apparatus comprising a pump, a resin reservoir, a reservoir inline, a closed mold, and a resin batch. A preferred method for forming the wheel is a modified infusion process. First, a honeycomb core is sandwiched between layers of composite fiber. Additional composite fiber is then wrapped circumferentially around the sandwich, thereby completely enclosing the honeycomb core. The mold is then sealed from all directions, resin is pumped into the mold, and the excess is removed.

An alternative embodiment may employ a similarly modified transfer process.

### BRIEF DESCRIPTION OF THE DRAWINGS

FIG. 1 is a front view of a honeycomb core.

FIG. 2 is a side view of a honeycomb core.

FIG. 3 is an isometric view of a honeycomb core.

FIG. 4 is a front view of the invention.

FIG. 5 is a side view of the invention.

FIG. 6 is an isometric view of the invention.

FIG. 7 is an exploded view of a mold.

FIG. 8 is a perspective view of an exemplary apparatus for forming the invention.

### DESCRIPTION OF THE PREFERRED EMBODIMENT(S)

In the following detailed description of the preferred embodiments, reference is made to the accompanying drawings, and in which are shown by way of illustration specific embodiments in which the invention may be practiced. It is to be understood that other embodiments may be utilized and structural changes may be made without departing from the scope of the present invention.

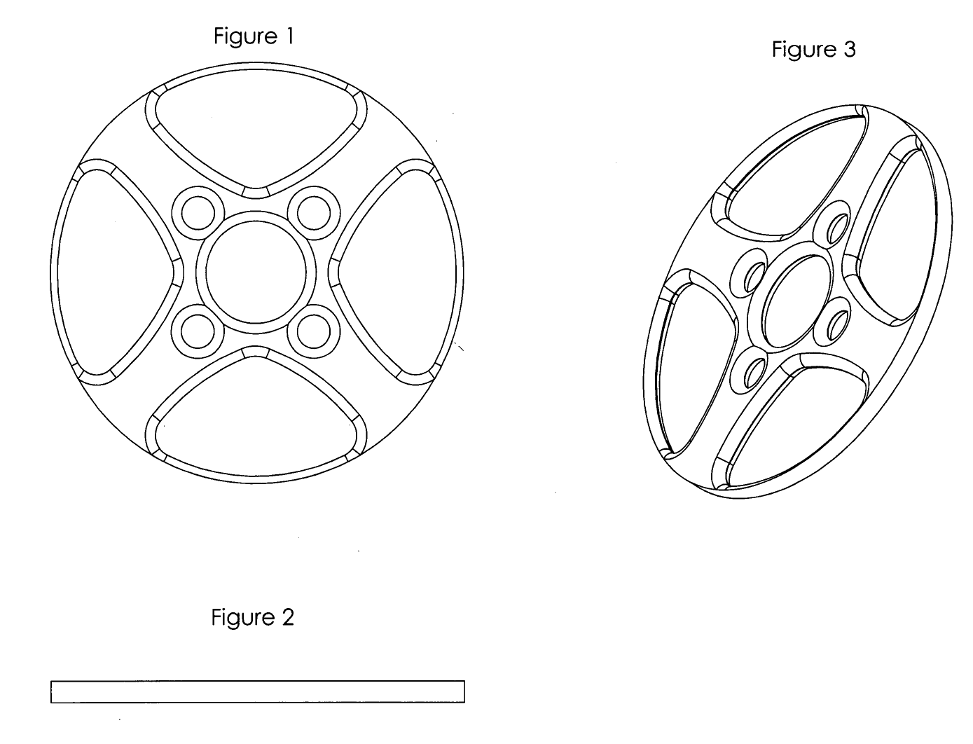

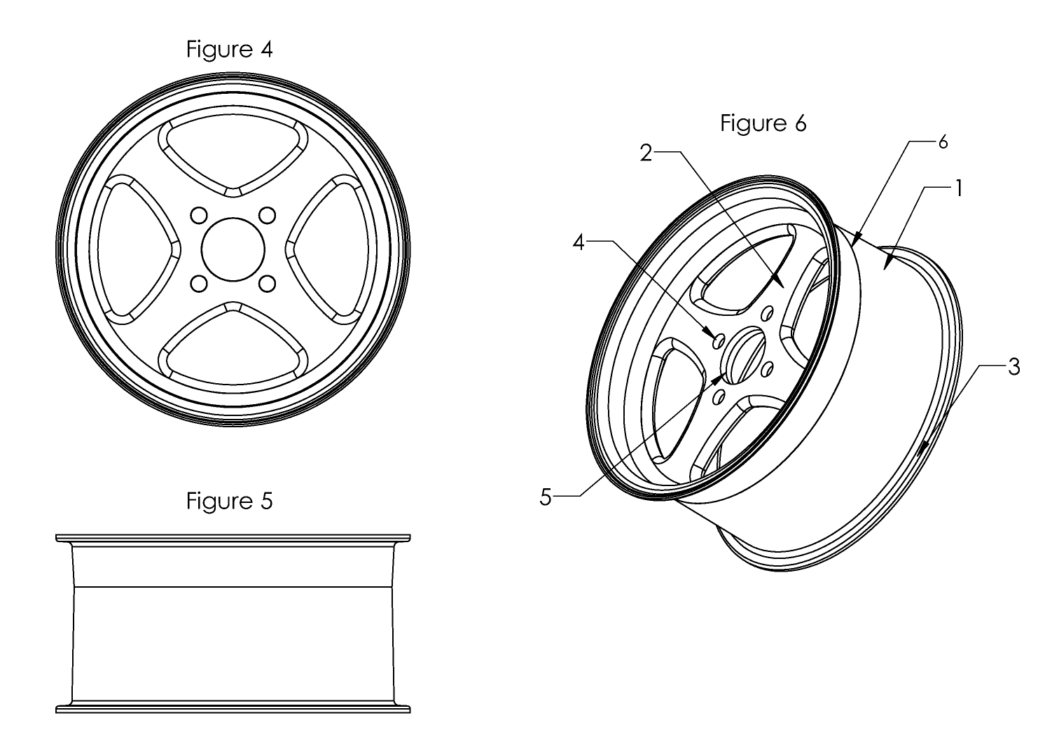

FIGS. 1-3 depict various views of the three-dimensional honeycomb core. The three-dimensional honeycomb core is a structural member embedded within the invention to add strength and stiffness with a minimum of increased weight. The size of the core depends on the specific application, but may in typical scenarios vary from three inches in diameter to larger than ten feet, as could be the case in heavy construction equipment applications. However, there are no size limitations except as required by a particular application. The thickness of a three-dimensional honeycomb core varies similarly, with typical thicknesses appearing from 1/16^{th} of an inch to several feet. Again, the application would dictate the specific dimensions. The structure of the three-dimensional honeycomb core is known in the art, and may be similar to that used in Trussgrid™. The composition of the material comprising the three-dimensional honeycomb core may be aluminum, titanium, plastic, wood, foam, or any material with substantial stiffness and strength so long as it is lightweight, and the honeycomb structure is used.

FIGS. 4-6 depict various views of a preferred embodiment of the invention. FIG. 6 refers to rim 1, disc 2, bead seat 3, lug nut holes 4, axel hole 5, and drop center 6. Rim 1 and disc 2 are of a single composite piece where the previously described three-dimensional honeycomb core is embedded within disc 2. Bead seat 3 is a circular protrusion that assists in keeping a tire in place. Bead seat 3 may be an insert integrally imbedded as with the core, and may be comprised of aluminum, titanium, plastic, wood, foam, or any material that serves the purpose of securing the tire to the rim. Lug nut hole 4 is used in a conventional manner as is axel hole 5. Lug nut hole 4 and axel hole 5 may be reinforced with inserts.

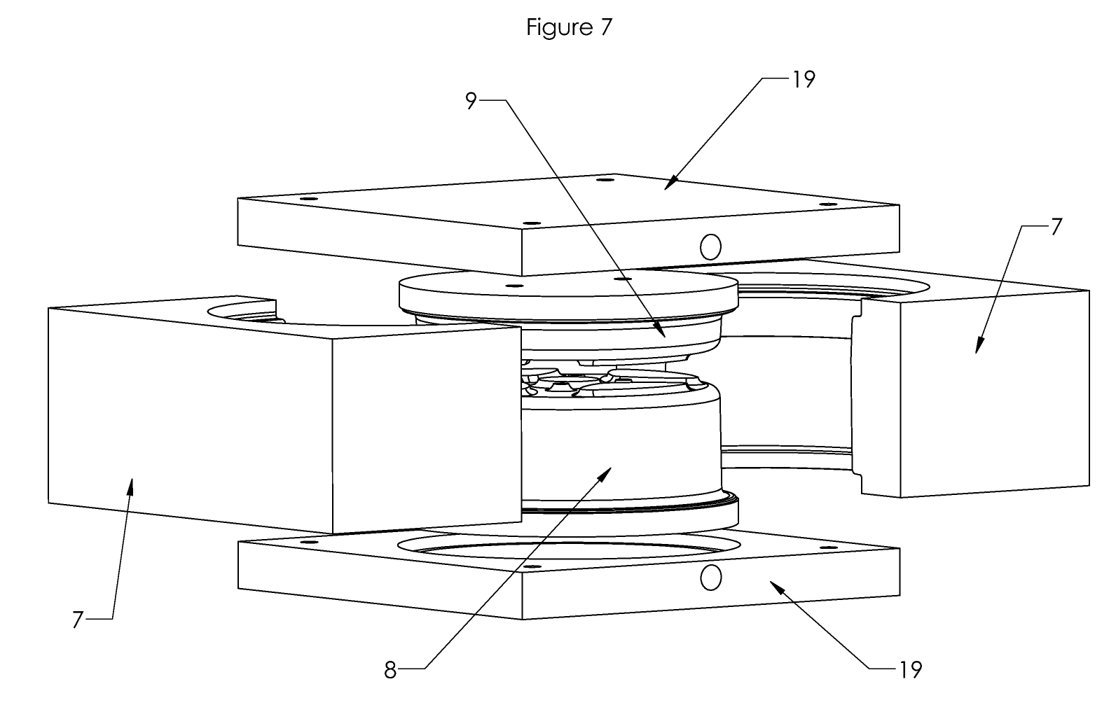

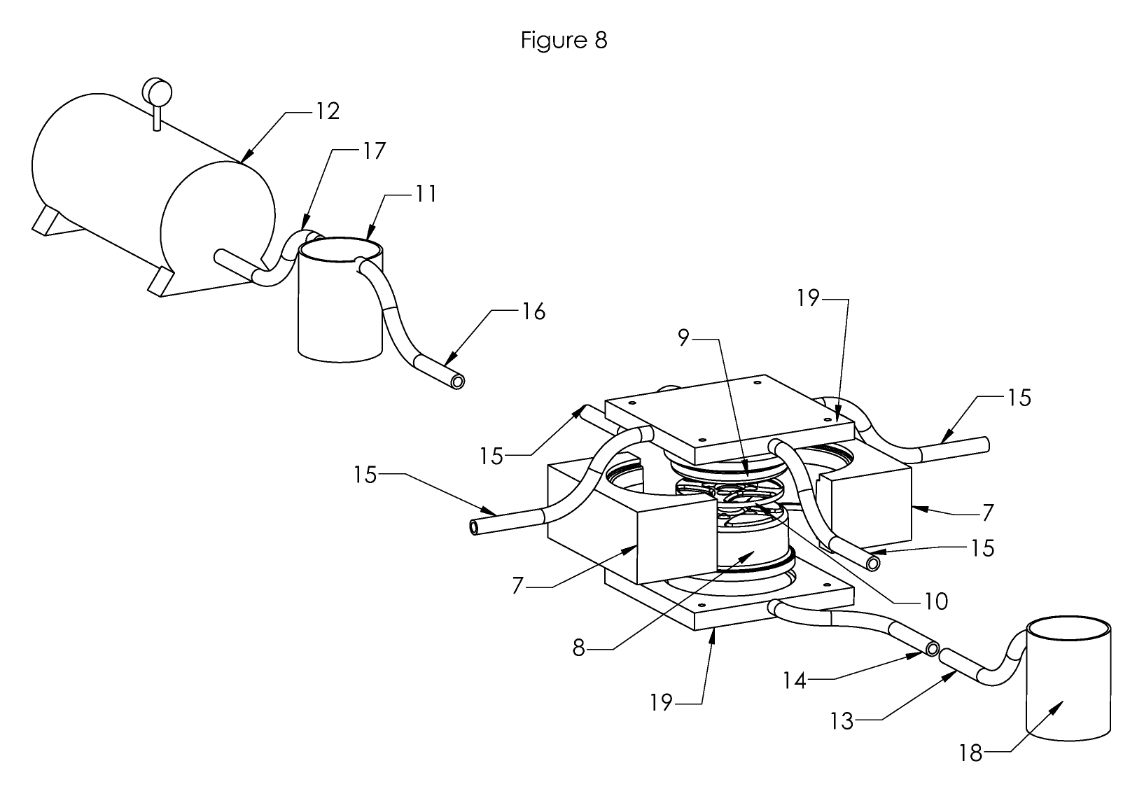

FIG. 7 depicts the mold used to form the invention. FIG. 8 depicts an exemplary apparatus performing the invention that includes the use of the mold depicted in FIG. 7. Referring to FIG. 8, the apparatus comprises resin source 5, base plate mold 6, side mold 7, inside mold 8, outside mold 9, three-dimensional honeycomb core 10, resin reservoir 11, vacuum pump 12, resin feeding tubing 13, inline resin tubing 14, exit resin tubing 15, resin reservoir inline 16, and vacuum tubing 17. Resin source 5 delivers resin or any other suitable substitute into the system. Base plate mold 6 is machined from typical mold materials such as aluminum. It is the base of the closed mold and is joined to the resin feeding tubing or exit resin tubing, and to the rest of the pieces of the closed mold. Side mold 7 is also machined from typical mold materials such as aluminum and it is joined between the base plates and closes the inner molds. Inside mold 8 is machined from typical mold materials such as aluminum and is joined to the bottom of the base plate by conventional means. The inside mold creates the interior design of the wheel or the hub side. Outside mold 9, also machined from typical mold materials such as aluminum, is joined with top base plate by conventional means. The outside mold creates the outside design of the wheel. Three-dimensional honeycomb core 10 is previously described with respect to FIGS. 1-3. Resin reservoir 11 is a pressurized container that is connected to a vacuum pump and collects the excess resin from the system. The purpose of the reservoir is to prevent resin from reaching the vacuum pump and damaging it. Vacuum pump 12 is used to infuse resin into the system at the necessary pressure. In operation, the honeycomb core is sandwiched between layers of composite fiber. The bead seat may be included with the core, if desired. Additional composite fiber is then wrapped circumferentially around the sandwich, thereby completely enclosing the honeycomb core and bead seat, if included. The mold is then sealed from all directions, resin is pumped into the mold and the excess is subsequently removed. The material in the mold is allowed to cure and it is removed from the mold, trimmed, sanded, clear-coated, and the process is complete.

Although specific embodiments may have been illustrated and described herein, it is appreciated by those of ordinary skill in the art that any arrangement which is calculated to achieve the same purpose may be substituted for the specific embodiments shown. This application is intended to cover any adaptations or variations of the present invention. Therefore, it is intended that the invention be limited only by the claims and their equivalents.

1. A composite wheel, comprising, a rim, a disc and a core, whereby the core is embedded within the disc, and wherein the rim and the disc are of a single composite piece.

2. The device of claim 1 wherein the core is a three-dimensional honeycomb core.

3. The device of claim 2 wherein the three-dimensional honeycomb core is comprised of aluminum.

4. The device of claim 2 wherein the three-dimensional honeycomb core is comprised of titanium.

5. The device of claim 2 wherein the three-dimensional honeycomb core is comprised of plastic.

6. The device of claim 2 further comprising a bead seat insert.

7. (canceled)

8. (canceled)

9. The device of claim 2 wherein the three-dimensional honeycomb core comprises Trussgrid^{™}.

10. A method of forming a composite wheel comprising:
providing a three-dimensional honeycomb core for a disc portion of a wheel;
embedding the three-dimensional honeycomb core between layers of composite fiber;
surrounding the circumference of the three-dimensional honeycomb core with composite fiber to form a rim;
placing the three-dimensional honeycomb core and the composite fiber layers within a mold; and
infusing resin into the mold, wherein the rim and the disc are of a single composite piece.

11. The method of claim 10 wherein the three-dimensional honeycomb core comprises aluminum.

12. The method of claim 10 wherein the three-dimensional honeycomb core comprises Trussgrid^{™}.

13. The method of claim 10 further comprising the step of embedding a bead seat insert in the composite fiber layers.
